(19) United States
(12) Patent Application Publication
(10) Pub. No.: US 2026/0081819 A1
(43) Pub. Date: Mar. 19, 2026

(54) SYSTEMS AND METHODS TO DETECT AND MITIGATE FLUCTUATION AT N3 NETWORK INTERFACE WITHIN OPEN RADIO ACCESS NETWORK TELECOMMUNICATIONS NETWORKS

(71) Applicant: DISH Wireless L.L.C., Englewood, CO (US)

(72) Inventor: Manish Uniyal, Parker, CO (US)

(21) Appl. No.: 18/886,643

(22) Filed: Sep. 16, 2024

(51) Int. Cl. H04L 41/0654; H04L 41/0631; H04L 43/10

(52) U.S. Cl. CPC H04L 41/0654; H04L 41/0631; H04L 43/10

(57) ABSTRACT

Systems and methods to mitigate fluctuation within telecommunication networks. One system may include a processing system configured to determine whether transmission of a ping included in a series of pings failed, wherein the series of pings are transmitted between a first network element and a second network element connected via a network interface. The processing system may be configured to determine whether an attempt to exchange a plurality of echo messages between the first network element and the second network element via the network interface generated an error indication message. The processing system may be configured to, responsive to a determination that the ping failed and that the error indication message was generated, detect a fluctuation condition for the network interface. The processing system may be configured to execute a recovery action responsive to the fluctuation condition for the network interface.

### BACKGROUND

Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods to detect and mitigate fluctuation (or flapping) at network interfaces within telecommunication networks (e.g., at the N3 network interface within open radio access network telecommunications networks) to reduce disruption or downtime, which leads to traffic disruptions and adverse impacts to user experience.

According to one aspect of the present disclosure, a system to mitigate fluctuation at network interfaces within telecommunication networks. The system may include a processing system including one or more electronic processors. The processing system may be configured to determine whether transmission of a ping included in a series of pings failed, where the series of pings are transmitted between a first network element of a telecommunications network and a second network element of the telecommunications network connected via a network interface of the telecommunications network, and where transmission of the series of pings are associated with performance of a first connectivity test for the network interface. The processing system may be configured to determine whether an attempt to exchange a plurality of echo messages between the first network element and the second network element via the network interface generated an error indication message, where the attempt to exchange the plurality of echo messages are associated with performance of a second connectivity test for the network interface. The processing system may be configured to, responsive to a determination that the ping failed and that the error indication message was generated, detect a fluctuation condition for the network interface. The processing system may be configured to execute a recovery action responsive to the fluctuation condition for the network interface.

According to another aspect of the present disclosure, a method to mitigate fluctuation at network interfaces within telecommunication networks. The method may include determining, with a processing system including one or more electronic processors, whether transmission of a ping included in a series of pings failed, where the series of pings are transmitted between a first network element of a telecommunications network and a second network element of the telecommunications network connected via a network interface of the telecommunications network, and where transmission of the series of pings are associated with performance of a first connectivity test for the network interface. The method may include determining, with the processing system, whether an attempt to exchange a plurality of echo messages between the first network element and the second network element via the network interface generated an error indication message, where the attempt to exchange the plurality of echo messages are associated with performance of a second connectivity test for the network interface. The method may include detecting, with the processing system, a fluctuation condition for the network interface when the ping failed and the error indication message was generated. The method may include executing, with the processing system, a recovery action responsive to the fluctuation condition for the network interface.

According to another aspect of the present disclosure, a non-transitory computer-readable medium is provided. The non-transitory computer-readable medium stores instructions that, when executed by one or more electronic processors of a processing system in a telecommunications network, cause the processing system to perform operations comprising: determining whether transmission of a ping included in a series of pings failed, where the series of pings are transmitted between a first network element of the telecommunications network and a second network element of the telecommunications network connected via a network interface of the telecommunications network, where transmission of the series of pings are associated with performance of a first connectivity test for the network interface; determining whether an attempt to exchange a plurality of echo messages between the first network element and the second network element via the network interface generated an error indication message, where the attempt to exchange the plurality of echo messages are associated with performance of a second connectivity test for the network interface; detecting a fluctuation condition for the network interface when transmission of the ping failed and the error indication message was generated; and executing a recovery action responsive to the fluctuation condition for the network interface.

In some examples, the network interface of the telecommunications network may be an N3 interface within an open radio access network telecommunications network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 schematically illustrates an example of a server in accordance with various aspects of the present disclosure.

FIG. 4 illustrates an example diagram of a control plane path and a user plane path between a radio access network and a 5G Core of a telecommunications network in accordance with various aspects of the present disclosure.

FIG. 5 schematically illustrates an example of a computing device in accordance with various aspects of the present disclosure.

FIG. 6 is a flowchart of an example method to detect and mitigate fluctuation within telecommunication networks in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (UE) (e.g., mobile phones and the like). As another example, the wireless communication networks described herein may comply with other industry standards, such as, e.g., the Distributed Radio Access Network (Distributed RAN or D-RAN) or the like. In some configurations, the wireless communication network may be another type of wireless network, such as, for example, a sixth generation (6G), wireless network.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

Accordingly, the technology disclosed herein provides methods and systems to detect and mitigate fluctuation within telecommunication networks. In some configurations, the technology disclosed herein provides methods and systems to identify N3 interface flapping or fluctuation in an O-RAN network. Timely identification of N3 interface fluctuation can, for example, reduce user plane issues, subscriber impact, and resolution time, which, ultimately, reduces network impact and downtime. For instance, any disturbance or downtime resulting from fluctuation in the N3 interface may lead to traffic disturbance and user experience impact in the network. Accordingly, the technology disclosed herein provides systems and methods that mitigate resolution delays such that N3 services may be restored promptly and, in particular, prior to further impacts on the network as a whole.

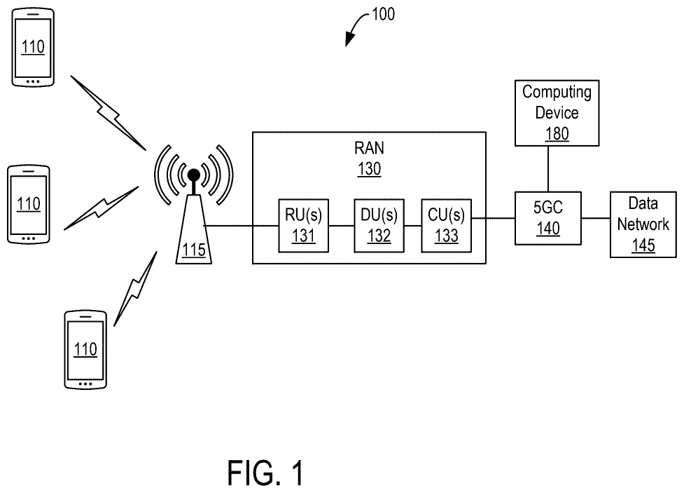

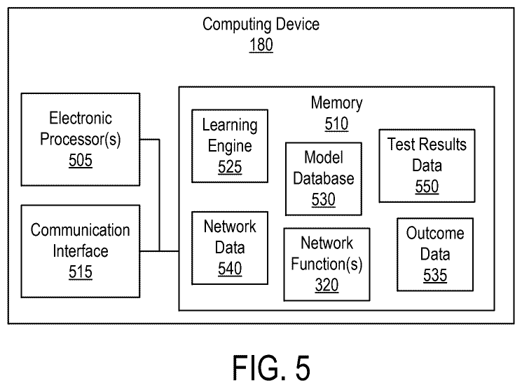

FIG. 1 illustrates an example of a telecommunications network 100 in accordance with various aspects of the present disclosure. In the telecommunications network 100 of FIG. 1, one or more user equipment (UE) 110 may be connected to a wireless access point 115, which in turn may be connected to a radio access network (RAN) 130, including, e.g., one or more radio units (RUs) 131, distributed units (DUs) 132, centralized units (CUs) 133, or a combination thereof. In some configurations, the RAN 130 may be implemented as a virtualized RAN 130. As noted herein, the O-RAN model follows a virtualized model for a 5G wireless architecture in which 5G base stations (e.g., gNBs) are implemented using separate CUs, DUs, and RUs. In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Accordingly, in some configurations, the RAN 130 may be implemented in accordance with the O-RAN model, such that the RUs 131, the DUs 132, or CUs 133 may be O-RAN RUs, CUs, or DUs. The RAN 130 may provide a connection to a 5G core network (5GC) 140, which in turn may provide a connection to a data network 145, a computing device 180, or a combination thereof. The data network 145 may be the Internet, an enterprise data network, combinations thereof, or the like. The computing device 180 is described in greater detail herein with respect to FIG. 5. The wireless access point 115 and the RAN 130 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized. For instance, in some implementations, the telecommunication network 100 may be implemented using one or more virtualized RAN components, such as, e.g., one or more virtualized RUs, virtualized DUs, virtualized CUs, or a combination thereof. In some configurations, the telecommunication network 100 may be implemented pursuant to the O-RAN model, as described herein. Accordingly, in some instances, the telecommunications network 100 may be an O-RAN telecommunications network.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), or any computerized device capable of communicating via a cellular network. More generally, the UEs 110 can represent any type of device that has an incorporated 5G interface, such as, e.g., a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connect. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 131. The RU(s) 131 are configured to convert radio signals sent to and received from the antenna(s) into a digital signal. The wireless access point 115 is connected to the RAN components 130 via a fronthaul link (represented in FIG. 1 by reference numeral 150) over which the digital signals may be communicated. The DU(s) 132 may be connected to the CU(s) 133 via a midhaul link (represented in FIG. 1 by reference numeral 155). The CU(s) 133 may be connected to the 5GC 135 via a backhaul link (represented in FIG. 1 by reference numeral 160). While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU 132 and a number of RUs 131 (e.g., six RUs 131) assigned to it.

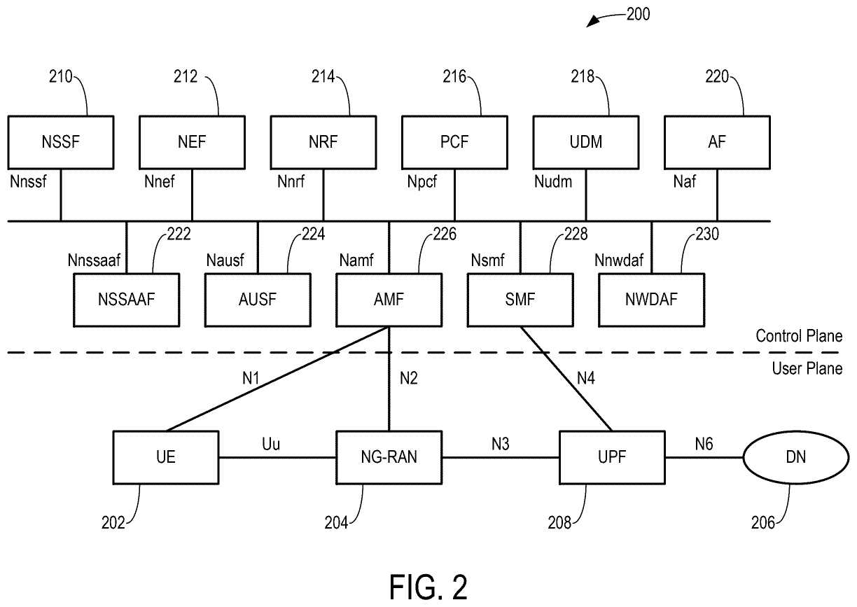

The 5GC 140 provides a plurality of 5G core functions. In the topology of a 5G NR cellular network, 5G core functions of 5GC 140 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within a regional data center (RDC) are described in more detail with regard to FIG. 2. The data network 145 may be the Internet, an enterprise data network, combinations thereof, or the like.

FIG. 2 illustrates an example architecture 200 for a telecommunications network (e.g., the telecommunications network 100 of FIG. 1) in accordance with various aspects of the present disclosure. In some instances, the architecture 200 may be a service-based architecture (SBA), such as, e.g., a SBA based on HTTP2. The architecture 200 may be divided between a control plane (CP) and a user plane (UP). The CP may include a plurality of CP network functions (NFs). The UP may include a UE 202 (e.g., one of the UEs 110 of FIG. 1) connected to an NG-RAN 204, and UP NFs (e.g., a User Plane Function (UPF) 208). In some implementations, using the architecture 200, the UE 202 may access a data network 206 (e.g., the data network 140 of FIG. 1). For ease of illustration, FIG. 2 only shows a single UE 202 being connected to the NG-RAN 204; however, in practical implementations, any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The SBA 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

For purposes of explanation, the technology disclosed herein will be described as being implemented in a 5G O-RAN network; however, in practice technology disclosed herein may be implemented with any RAN architecture (including, e.g., any virtualized RAN architecture). Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as described herein (e.g., including one or more individual electronic processors). A data center server is an example of such a processing system that may perform the methods described herein.

As described herein with respect to FIG. 1, the 5GC 140 provides a plurality of 5G core functions, which may reside and/or execute via one or more data centers (e.g., one or more NDCs or RDCs), including, e.g., one or more data center servers. For instance, in some configurations, the data center server(s) may store and execute a set of instructions for executing one or more NF as described herein. Additionally, in some embodiments, the data center server may be a local server located at corresponding cell site(s) (e.g., as part of an on-site computing platform of a corresponding wireless access point 115 or cell site). Alternatively, or in addition, in some embodiments, the data center server may be a remote cloud server located remotely from corresponding cell site(s).

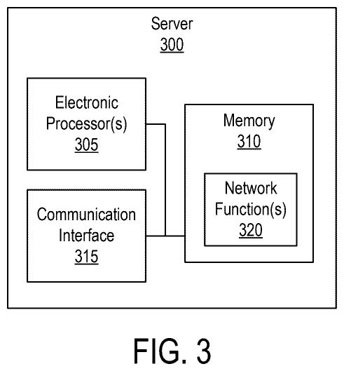

For example, FIG. 3 schematically illustrates an example server 300 (e.g., a data center server for the 5GC 140 of FIG. 1) according to some configurations. As illustrated in FIG. 3, the server 300 includes an electronic processor 305, a memory 310, and a communication interface 315. The electronic processor 305, the memory 310, and the communication interface 315 may communicate wirelessly, over one or more communication lines or buses, or a combination thereof. The server 300 may include additional, different, or fewer components than those illustrated in FIG. 3 in various configurations. The server 300 may perform additional or different functionality than the functionality described herein. Also, the functionality (or a portion thereof) described herein as being performed by the server 300 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The communication interface 315 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The electronic processor 305 includes one or more electronic processors (e.g., one or more microprocessors, one or more application-specific integrated circuits (ASICs), and/or one or more other suitable electronic device for processing data), and the memory 310 includes a non-transitory, computer-readable storage medium. The electronic processor 305 is configured to retrieve instructions and data from the memory 310 and execute the instructions. For example, as illustrated in FIG. 3, the memory 310 may store one or more network functions 320 (also referred to herein as the NFs 320). The NFs 320 may include, e.g., one or more of the network functions described herein, such as, e.g., with respect to FIG. 2.

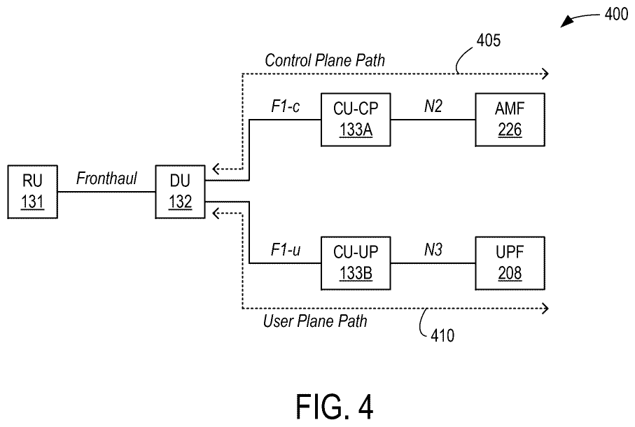

FIG. 4 illustrates an example diagram 400 of a control plane path 405 and a user plane path 410 with respect to the interface(s) between the RAN 130 and the 5GC 140 in accordance with various aspects of the present disclosure. For instance, as illustrated in FIG. 4, the control plane path 405 may include an F1-c interface between the DU 132 and a CU of the control plane (represented in FIG. 4 by and referred to herein as the CU-CP 133A) and the N2 interface between the CU-CP 133A and AMF 226. The user plane path 410 may include an F1-u interface between the DU 132 and a CU of the user plane (represented in FIG. 4 by and referred to herein as the CU-UP 133B) and the N3 interface between the CU-UP 133B and the UPF 208.

As noted herein, in some configurations, the telecommunications network 100 may include the computing device 180. In some instances, the computing device 180 may be coupled to the 5GC 140, as illustrated in the example of FIG. 1. Alternatively, or in addition, in some configurations, the computing device 180 may be included as a component or element of the 5GC 140. In some examples, the computing device 180 may be an example of the server 300 of FIG. 3 (e.g., a data center server for the 5GC 140 of FIG. 1).

As illustrated in FIG. 5, the computing device 180 includes an electronic processor 505, a memory 510, and a communication interface 515. The electronic processor 505, the memory 510, and the communication interface 515 may communicate wirelessly, over one or more communication lines or buses, or a combination thereof. The computing device 180 may include additional, different, or fewer components than those illustrated in FIG. 5 in various configurations. The computing device 180 may perform additional or different functionality than the functionality described herein. Also, the functionality (or a portion thereof) described herein as being performed by the computing device 180 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The communication interface 515 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The electronic processor 505 includes one or more processors (e.g., one or more microprocessors, one or more application-specific integrated circuits (ASICs), and/or one or more other suitable electronic device for processing data), and the memory 510 includes a non-transitory, computer-readable storage medium. The electronic processor 505 is configured to retrieve instructions and data from the memory 510 and execute the instructions.

For example, as illustrated in FIG. 5, the memory 510 may store one or more network functions 320. The network functions 320 may include, e.g., one or more of the network functions described herein, such as, e.g., with respect to FIG. 2.

As also illustrated in FIG. 5, the memory 510 may also include a learning engine 525 and a model database 530. In some configurations, the learning engine 525 develops one or more models using one or more machine learning functions. Machine learning functions are generally functions that allow a computer application to learn without being explicitly programmed. In particular, the learning engine 525 is configured to develop an algorithm or model based on training data. As one example, to perform supervised learning, the training data includes example inputs and corresponding desired (for example, actual) outputs, and the learning engine 525 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 525 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 525 to ingest, parse, and understand data and progressively refine models.

Models generated by the learning engine 525 can be stored in the model database 530. As illustrated in FIG. 5, the model database 530 may be included in the memory 505 of the computing device 180. It should be understood, however, that, in some configurations, the model database 530 may be included in one or more separate devices accessible by the computing device 180 of FIG. 5 (including a remote database, and the like).

As one example, the learning engine 525 may develop a fluctuation prediction model. The fluctuation prediction model may be an artificial intelligence or machine learning model trained to predict fluctuation (or flapping) associated with one or more network elements of the telecommunications network 100. As used herein, a network element may represent a network function or network function pod (e.g., the CU-UP 133A, the UPF 208, etc.), a network interface (e.g., the N3 interface, the N2 interface, etc.), or another component or element included in the telecommunications network 100. As described herein, in some instances, the technology disclosed herein may utilize fluctuation predictions in order to identify one or more network conditions (or triggers) that may result in (or otherwise cause) fluctuation at one or more network elements. In some instances, the technology disclosed herein may utilize the fluctuation predictions to proactively (or preemptively) management network maintenance, such as, e.g., generating (or otherwise providing) maintenance alerts or notifications. In some examples, the technology disclosed herein may detect or predict fluctuations with respect to the N3 interface within a O-RAN telecommunications network (e.g., the telecommunications network 100).

For example, the learning engine 525 may train the fluctuation predication model to identify trends within network data that may indicate a fluctuation with respect to one or more network elements of the telecommunications network 100 and, ultimately, predict a fluctuation (or fluctuation condition) with respect to the one or more network elements of the telecommunications network 100. In some examples, the fluctuation prediction model may identify trends that indicate a fluctuation for the N3 interface within O-RAN telecommunications network (e.g., the telecommunications network 100). For instance, the fluctuation prediction model may receive, as input, network data, including, e.g., information or data related to present operating conditions or metrics of the telecommunications network 100. The fluctuation prediction model may analyze the network data in order to identify one or more trends within the network data, where those one or more trends may indicate (or otherwise anticipate) a fluctuation condition with respect to one or more network elements of the telecommunications network 100 (e.g., the N3 interface). Accordingly, in some configurations, the fluctuation prediction model may provide, as output, a fluctuation condition or prediction with respect to one or more network elements of the telecommunications network 100, including, e.g., the N3 interface within O-RAN telecommunications networks.

The learning engine 525 may develop (or train) the fluctuation prediction model using training data. In some configurations, the training data may include historical network data associated with the telecommunications network 100 (or network element(s) therein). For instance, the training data may include previous network conditions or metrics during fluctuation, prior to fluctuation, after fluctuation, or a combination thereof. As one example, the training data may include network conditions for a network element, such as, e.g., the N3 interface, while the network element experienced fluctuation, after the network element experienced fluctuation, before the network element experienced fluctuation, or a combination thereof. As another example, the training data may include network conditions for a first network element while a second network element experienced fluctuation, after the second network element experienced fluctuation, before the second network element experienced fluctuation, or a combination thereof.

Alternatively, or in addition, the training data may include information related to an outcome (or impact) of performing a recovery action (e.g., referred to herein as outcome data 535). As described in greater detail herein, a recovery action may include an action performed with respect to a network element, such as, e.g., the N3 interface, experiencing fluctuation in an attempt to mitigate, eliminate, or avoid the fluctuation. As one example, a recovery action may include restarting the network element (e.g., a network function or a network function pod associated with or experiencing the fluctuation). As another example, a recovery action may include rerouting communication links between network elements (e.g., rerouting communication links from a first network element experiencing fluctuation to a second, different network element during remediation of the fluctuation at the first network element). As yet another example, a recovery action may include re-assigning one or more internet protocol (IP) addresses (e.g., re-assigning an IP address of a network element experiencing fluctuations).

The outcome data 535 may indicate whether a recovery action was successful in remediating a fluctuation. The outcome data 535 may be particular (or specific) to a network element (e.g., the N3 interface), one or more network conditions or metrics, etc. For example, the success of a recovery action in remediating fluctuation may depend on (or be based on) a specific network element, specific network conditions or metrics, or a combination thereof. As one example, a recovery action may be successful for a first network element (e.g., the N2 interface) but unsuccessful for a second, different network element (e.g., the N3 interface). Accordingly, in some configurations, the training data may include various combinations of recovery actions, network elements (e.g., the N3 interface), network conditions, an outcome of performing the recovery actions, or a combination thereof. In some instances, the outcome data 535 may include the outcome of performing a recovery action in association with the recovery action performed, the network elements associated with performance of the recovery action, the network conditions associated with performance of the recovery action, etc.

Alternatively, or in addition, in some configurations, the training data may relate to an outcome or result of one or more connectivity tests performed for the telecommunications network 100 (or network element(s) thereof) (e.g., the test results data 550), including, e.g., whether an outcome of a first connectivity test is confirmed by a second connectivity test. As described in greater detail herein, in some configurations, the technology disclosed herein may perform a first connectivity test and a second connectivity test, where the results of the second connectivity test may be utilized to confirm the results of the first connectivity test. In some examples, when the first connectivity test indicates a connectivity issue with respect to a network interface (e.g., the N3 interface), the results of the second connectivity test may be utilized to confirm whether the network interface (e.g., the N3 interface) is actually experiencing (or otherwise associated with) the connectivity issue indicated by the first connectivity test, as described in greater detail herein. As one example, when the first connectivity test indicates a connectivity issue at the N3 interface and the second connectivity test indicates a connectivity issue at the N3 interface, then the connectivity issue at the N3 interface may be confirmed (or verified) as, e.g., fluctuation or flapping at the N3 interface. As another example, when the first connectivity test indicates a connectivity issue at the N3 interface and the second connectivity test does not indicate a connectivity issue at the N3 interface, then the connectivity issue at the N3 interface may not be confirmed (or verified). As such, in some instances, the learning engine 525 may develop the fluctuation prediction model based on whether or not a connectivity issue was confirmed for a particular network element, such as, e.g., the N3 interface, given a particular set of network conditions (as training data). Accordingly, in some configurations, the training data may include whether, given a particular network element or network conditions, a connectivity issue was confirmed (or otherwise verified).

In some configurations, the memory 510 may store network data 540. The network data 540 may include information or data relating to the telecommunications network 100, including one or more network elements or resources thereof (e.g., the RUs 131, the DUs 132, the CUs 133, etc.). In some examples, the network data 540 may include or otherwise indicate a network demand (or an amount of network traffic) at a particular network resource, network traffic flow within the telecommunications network 100 (or components thereof), or the like. In some configurations, the network data 540 may include one or more key performance indicators (KPIs) (either at a network level or component level). KPIs may relate to availability, integrity, and mobility of the telecommunications network 100 (or component(s) thereof). A KPI generally refers to a quantifiable measurement of performance for a telecommunications network (or component(s) thereof). Example KPIs may include, e.g., peak data rate, peak spectral efficiency, data rate experienced by user, area traffic capacity, latency, connection density, average spectral efficiency, energy efficiency, reliability, mobility, mobility interruption time, bandwidth, mid haul transport congestion, backhaul transport congestion, number of radio bearers, active scheduled user over a measurement period and per transmit time interval, etc. As such, KPI(s) may provide insight(s) into network traffic demand and flow within the telecommunications network 100 (or components thereof).

The memory 510 may store test results data 550. The test results data 550 may include information or data relating to results or outcomes of one or more connectivity tests performed with respect to the telecommunications network 100 (or components thereof). The connectivity tests performed with respect to the telecommunications network 100 may include a ping test (also referred to herein as a first connectivity test) and an echo messaging test (also referred to herein as a second connectivity test).

In some configurations, the connectivity tests (e.g., the ping test and the echo messaging test) may be performed with respect to a network interface of the telecommunications network 100 (e.g., to detect fluctuation or flapping at the network interface). As one example, the connectivity tests may be performed with respect to the N3 interface to detect fluctuation at the N3 interface. Performance of the connectivity tests may be performed by the network elements (or network functions or pods) connected via the network interface. As one example, with reference to FIG. 4, the CU-UP 133A and the UPF 208 may perform the connectivity test(s) in order to detect fluctuation at the N3 interface (e.g., with respect to the N3 interface). In some configurations, performance of the connectivity test(s) may be (or included as part of) pre-existing protocols or operation. For example, performance of the connectivity test(s) may already be performed by the network functions (or pods) as part of the normal operation of the network functions (or pods). Accordingly, in some instances, generation of the test results data 550 may occur as a result of normal operation of the telecommunications network 100 (or network element(s) thereof). Alternatively, or in addition, in some instances, another component of the telecommunications network 100, such as, e.g., the computing device 180, may trigger or control performance of the connectivity test(s) described herein.

The ping test may include the transmission of a series of pings (e.g., five pings, ten pings, etc.) between two network elements via a network interface, such as, e.g., the transmission of pings between the CU-UP 133B and the UPF 208 via the N3 interface. As one specific example, the ping test may include the transmission of at least five pings between two network elements. The transmission of at least five pings may result in improved consistency with respect to the result set of the ping test. In some configurations, the series of pings may be continuous (e.g., five continuous pings). The test results for the ping test may indicate or otherwise include whether any of the pings failed (e.g., whether transmission of a ping included in the series of pings failed). A failed transmission of one or more of the pings included in the series of pings may indicate a connectivity issue (or fluctuation condition) with respect to the network interface (e.g., the N3 interface). For instance, when one or more of the pings fails, the test results for the ping test may indicate a connectivity issue (or fluctuation condition). When each ping, included in the series of pings, is are successfully transmitted, the test results for the ping test may indicate no connectivity issues (or no fluctuation condition).

Accordingly, in some configurations, the test results data 550 may indicate whether transmission of a ping included in a series of pings failed. In some instances, the test results data 550 may indicate additional information related to the ping test, such as, e.g., how many pings of the series of pings failed, which pings of the series of pings failed, a timestamp or date that the first connectivity test as performed, a network element in which the first connectivity test was performed on (e.g., a network interface, network element(s), etc.), or the like. In some configurations, the rest results data 550 for the first connectivity test may include a failure indicator associated with an instance of the first connectivity test. In such configurations, whether a ping failed may be determined as part of performing the first connectivity test.

The echo messaging test may include an exchange of (or an attempt to exchange) echo messages between network elements via a network interface, such as, e.g., the CU-UP 133B and the UPF 208 via the N3 interface. In some examples, the exchange of the echo messages may an echo request, an echo response, an error indication message, or a combination thereof. The echo request may be transmitted from a first network element to a second network element. The echo response may be transmitted from the second network element to the first network element responsive to receipt of the echo request at the second network element. The error indication message may be generated responsive to a failure with respect to the echo request, the echo response, or a combination thereof. Such a failure may include, e.g., a failed transmission of the echo response from the second network element to the first network element, a delayed transmission of the echo response from the second network element to the first network element, or the like. For example, when the first network element does not receive the echo response from the second network element (e.g., a failed transmission), the error indication message may be generated. As another example, when the first network element receives the echo response, but the echo response was delayed in arriving at the first network element (e.g., a delayed transmission), the error indication message may be generated.

As one example, with respect to FIG. 4, when the first network element is the CU-UP 133B, the second network element is the UPF 208, and the network interface is the N3 interface, the CU-UP 133B may transmit an echo request to the UPF 208 via the N3 interface. Responsive to receiving the echo request, the UPF 208 may transmit an echo response to the CU-UP via the N3 interface. When the echo response is not delivered or is delayed, the error indication message may be generated, which may indicate a connectivity issue with respect to the N3 interface (e.g., a fluctuation condition at the N3 interface).

Accordingly, in some configurations, the test results data 550 may indicate whether the exchange of echo messages included (or resulted with) generation of an error indication message. In some examples, the test result data 550 may include the error indication message (or content thereof). In some instances, the test results data 550 may indicate additional information related to the echo messaging test, such as, e.g., a timestamp or date that the echo messaging test was performed, one or more network elements involved in performance of the echo messaging test (e.g., the first network element, the second network element, the network interface, etc.), whether the echo messaging test included a delayed transmission or a failed transmission, etc.

The memory 505 may include additional, different, or fewer components in different configurations than illustrated in FIG. 5. Alternatively, or in addition, in some configurations, one or more components of the memory 505 may be combined into a single component, distributed among multiple components, or the like. Alternatively, or in addition, in some configurations, one or more components of the memory 505 may be stored remotely from the computing device 180, or, in a remote database, another server, a remote user device, an external storage device, or the like.

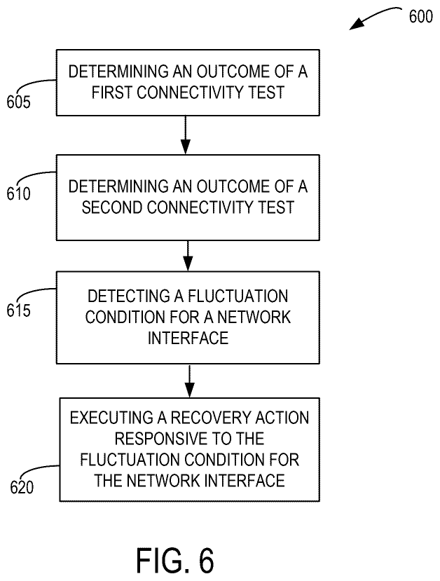

FIG. 6 is a flowchart illustrating an example method 600 to detect and mitigate fluctuation within telecommunication networks in accordance with some configurations. The method 600 is described as being performed by the computing device 180 and, in particular, the electronic processor(s) 505. However, as noted above, the functionality (or a portion thereof) described with respect to the method 600 may be performed by other devices, such as, e.g., another server or device within the telecommunications network 100, or distributed among a plurality of devices, such as a plurality of servers included in a cloud service. Thus, although described as begin performed by the computing device 180, the method 600 may also be described as being performed by a processing system including one or more electronic processors (e.g., another processor or processors of the telecommunication network 100).

Additionally, the method 600 is described as being performed with respect to detecting and mitigating a fluctuation of the N3 interface within an O-RAN telecommunications network (e.g., the telecommunications network 100). However, as noted herein, the functionality (or portion thereof) described with respect to the method 600 may be performed with respect to other network elements, such as, e.g., the N2 interface or another network interface of the telecommunications network 100.

As illustrated in FIG. 6, the electronic processor 505 may determine an outcome of a first connectivity test (at block 605). For instance, the electronic processor 505 may determine the outcome of the first connectivity test (e.g., the ping test) by determining whether transmission of a ping included in a series of pings failed. The electronic processor 505 may determine whether transmission of a ping included in a series of pings failed by accessing the test results data 550 from the memory 510. As described in greater detail herein, the test results data 550 may include information or data relating to results or outcomes of one or more connectivity tests performed with respect to the telecommunications network 100 (or components thereof). As such, the electronic processor 505 may access the test results data 550 related to an outcome of the ping test in order to determine whether transmission of a ping included in a series of pings failed (e.g., as an outcome of the first connectivity test).

As one example, when the ping test is performed with respect to the N3 interface within an O-RAN telecommunications network (e.g., the telecommunications network 100), the electronic processor 505 may access the test results data 550 (or portion thereof) related to performance of the ping test with respect to the N3 interface, where the test results data 550 (or portion thereof) related to the performance of the ping test with respect to the N3 interface may indicate whether any of the pings transmitted as part of the ping test failed. Following this example, the electronic processor 505 may determine the outcome of the ping test based on whether transmission of one or more pings failed (as indicated by the test results data 550). When one or more pings failed, the electronic processor 505 may determine that the outcome of the first connectivity test indicates a connectivity issue (e.g., a failed outcome or an error outcome) with respect to the network interface (e.g., the N3 interface within an O-RAN telecommunications network).

In some configurations, the test results data 550 may directly indicate whether transmission of one or more pings failed. For example, the test results data 550 may associate a performance instance of the ping test with a status indicator or identifier represented a failed transmission (e.g., a failed status indicator). Alternatively, or in addition, in some configurations, the test results data 550 may indirectly indicate whether transmission of one or more pings failed. For example, when the test results data 550 includes raw data related to performance of the ping test, the electronic processor 505 may access the raw data and determine, based on the raw data, whether transmission of one or more pings failed. In some examples, raw data related to performance of the ping test may include, for a single performance instance of the ping test, an indication of whether each ping was successfully or unsuccessfully transmitted. In such examples, the electronic processor 505 may determine whether that single performance instance of the ping test is associated with any indications that a ping was unsuccessful, and, ultimately, determine an outcome of that performance instance of the ping test (e.g., whether transmission of one or more pings for that performance instance of the ping test failed).

In some configurations, the electronic processor 505 may determine whether the transmission of the ping included in the series of pings failed based on information or content provided via an element management system (EMS). An EMS includes a system or application (e.g., a software application) that enables management of one or more network elements included in a telecommunications network (e.g., the telecommunications network 100), including, e.g., management of functions or capabilities of each network element. For example, the EMS may generate and provide a graphical user interface (GUI) that enables a user to interact with (or otherwise view) information relating to the network element(s) of the telecommunications network 100, including, e.g., fault information, configuration information, accounting information, performance information, security information, etc. As such, when transmission of a ping (as part of performing the ping test) fails, the EMS may detect that the transmission of the ping failed and trigger an alarm or alert. As one example, the EMS may provide the alarm or alert via the GUI. Accordingly, in some instances, the electronic processor 505 may determine whether the transmission of the ping included in the series of pings failed by detecting whether an alarm of an EMS was triggered. When the alarm of the EMS is triggered, the electronic processor 505 may determine that the transmission of the ping failed. When the alarm of the EMS is not triggered (e.g., an absence of an alarm), the electronic processor 505 may determine that the transmission of the ping was successful (e.g., did not fail). In such configurations, the electronic processor 505 may access data associated with the EMS to detect the triggered alarm. Alternatively, or in addition, the electronic processor 505 and the EMS may cooperatively interact or communicate such that the electronic processor 505 may detect the triggered alarm.

The electronic processor 505 may determine an outcome of a second connectivity test (at block 610). In some configurations, the electronic processor 505 may determine the outcome of the second connectivity test subsequent to (or responsive to) determining the outcome of the first connectivity test (e.g., at block 605). For instance, the electronic processor 505 may determine the outcome of the second connectivity test (e.g., the echo messaging test) by determining whether an exchange (or an attempt to exchange) a plurality of echo messages between the first network element (e.g., the CU-UP 133B) and the second network element (e.g., the UPF 208) via the network interface (e.g., the N3 interface) generated an error indication message. The electronic processor 505 may determine whether the error indication message was generated by accessing the test results data 550 from the memory 510. As described in greater detail herein, the test results data 550 may include information or data relating to results or outcomes of one or more connectivity tests performed with respect to the telecommunications network 100 (or components thereof). As such, the electronic processor 505 may access the test results data 550 related to an outcome of the echo messaging test in order to determine whether the exchange of echo messages (or attempt thereof) generated the error indication message (e.g., as an outcome of the second connectivity test).

As one example, when the echo messaging test is performed with respect to the N3 interface, the electronic processor 505 may access the test results data 550 (or portion thereof) related to performance of the echo messaging test with respect to the N3 interface, where the test results data 550 (or portion thereof) related to the performance of the echo messaging test with respect to the N3 interface may indicate whether the exchange of echo messages (or an attempt thereof) generated the error indication message. Following this example, the electronic processor 505 may determine the outcome of the echo messaging test based on whether an error indication message was generated (as indicated by the test results data 550). When the error indication message is generated, the electronic processor 505 may determine that the outcome of the second connectivity test indicates a connectivity issue (e.g., a failed outcome or an error outcome) with respect to the network interface (e.g., the N3 interface).

Alternatively, or in addition, in some configurations, the electronic processor 505 may determine the outcome of the echo messaging test based on content of the error indication message. In some examples, the error indication message may be generated responsive to another condition or trigger. As such, in some instances, the electronic processor 505 may analyze content of the error indication message, and, when the error indication message indicates a connectivity issue (e.g., a failed transmission of the echo response, a delayed transmission of the echo response, etc.), the electronic processor 505 may determine that the outcome of the second connectivity test indicates a connectivity issue with respect to the network interface (e.g., the N3 interface). Accordingly, in some configurations, when the error indication message indicates or otherwise includes information related to a failure, the electronic processor 505 may determine that the outcome of the second connectivity test indicates a connectivity issue (e.g., a failed outcome or an error outcome) with respect to the network interface (e.g., the N3 interface).

The electronic processor 505 may detect a fluctuation condition for the network interface (at block 615). As used herein, a fluctuation condition may represent or indicate fluctuation or flapping at a network element (e.g., a network interface, such as the N3 interface). The electronic processor 505 may detect the fluctuation condition based on the outcome of the one or more connectivity tests, as described herein. For instance, in some configurations, the electronic processor 505 may detect the fluctuation condition based on an outcome of the ping test, an outcome of the echo messaging test, or a combination thereof.

As noted herein, the results or outcome of the ping test may indicate connectivity issues with respect to the network interface (e.g., the N3 interface). In some instances, such connectivity issues may be indicative of fluctuation or flapping at the network interface. However, in other instances, such connectivity issues may be indicative of another condition or issue related to the telecommunications network 100 (or the network element(s) therein). As such, in some instances, the technology disclosed herein may consider an outcome of the echo messaging test in addition to the outcome of the ping test. Accordingly, in some configurations, the electronic processor 505 may detect the fluctuation condition when the outcome of the ping test indicates a connectivity issue at the network interface (e.g., the N3 interface) and the outcome of the echo messaging test indicates a connectivity issue at the network interface (e.g., the N3 interface). For instance, in some examples, responsive to a determination that the ping failed (e.g., as an outcome of the ping test) and that the error indication message was generated (e.g., as an outcome of the echo messaging test), the electronic processor 505 may detect a fluctuation condition for the network interface.

In some examples, the electronic processor 505 may detect the fluctuation condition using the fluctuation prediction model described herein. Accordingly, in some configurations, the electronic processor 505 may predict fluctuation at the network interface (e.g., predict the fluctuation condition) using the fluctuation prediction model. As noted herein, the fluctuation prediction model may be trained to predict fluctuation (or flapping) associated with one or more network elements of the telecommunications network 100. For instance, the electronic processor 505 may apply the fluctuation prediction model to the outcomes of the connectivity tests (e.g., the test results data 550, the network data 540, or a combination thereof (e.g., as inputs to the fluctuation prediction model). Based on the outcomes of the connectivity tests, the network data 540, or a combination thereof, the fluctuation prediction model may output a fluctuation prediction with respect to fluctuation at the network interface. As one example, the fluctuation prediction model may predict that fluctuation may occur at the network interface (e.g., as the fluctuation condition) based on the outcomes of the connectivity tests, the network data 540, or a combination thereof.

The electronic processor 505 may execute a recovery action responsive to the fluctuation condition for the network interface (at block 620). As described in greater detail herein, a recovery action may include an action or operation performed to remediate the fluctuation at a respective network element. As one example, the recovery action may include restarting a network element (e.g., a network function or a network function pod associated with or experiencing the fluctuation). With reference to FIG. 4, when the fluctuation is at the N3 interface, the electronic processor 505 may restart the UPF 208 (or a UPF pod), the CU-UP 133B (or a CU-UP pod), or a combination thereof. As another example, the recovery action may include rerouting communication links between network elements (e.g., network functions or pods). Rerouting communication links between network elements may include, e.g., rerouting communication links from a network element experiencing fluctuation to a different network element. In some instances, the communication links may be temporarily rerouted (e.g., during remediation of the fluctuation at the first network element). As yet another example, the recovery action may include re-assigning one or more IP addresses (e.g., re-assigning an IP address of a network element experiencing fluctuations). In some instances, the electronic processor 505 may identify which recovery action to execute based on the fluctuation condition, the network interface, the network function(s) or pod(s), the network condition(s) or metric(s), etc.

In some configurations, the electronic processor 505 may validate the fluctuation condition for the network interface (e.g., the N3 interface). For instance, subsequent to executing the recovery action (e.g., at block 620), the electronic processor 505 may access data related to performance of the network interface (e.g., the network data 540). The electronic processor 505 may monitor or analyze the network data 540 in order to determine whether the network interface experienced a dip (or decrease) in performance (e.g., detect a decreased performance). Such a decrease in performance may indicate fluctuation occurred at the network interface. As such, when the electronic processor 505 detects a decreased performance of the network interface, the electronic processor 505 may validate that fluctuation occurred at the network interface (e.g., validate the fluctuation condition for the network interface).

Alternatively, or in addition, in some configurations, the electronic processor 505 may verify whether the network interface recovered from the fluctuation condition. For instance, in some configurations, the electronic processor 505 may access (or otherwise monitor) the network data 540 for the network interface (e.g., the N3 interface). When the network data 540 indicates an increased performance subsequent to the decreased performance (which may be indicative of fluctuation at the network interface), such an increased performance following a decreased performance may indicate (or verify) that the network interface recovered from the fluctuation. In some instances, such a recovery (or increased performance) may indicate that execution of the recovery action remediated the fluctuation at the network interface.

When the network data 540 does not indicate an increased performance, the electronic processor may detect an absence of an increased performance of the network interface subsequent to the decreased performance of the network interface. Such an absence of an increased performance may indicate that execution of the recovery action did not remediate the fluctuation at the network interface (e.g., the network interface did not recover from the fluctuation). Accordingly, in some configurations, responsive to detecting an absence of an increased performance, the electronic processor 505 may execute an additional recovery action. As one example, where the initial recovery action included restarting an effected network function (or pod), the additional recovery action may include, rerouting communication links, reassigning IP addresses, or a combination thereof (as described in greater detail herein).

As noted herein, information or data related to validating the fluctuation condition, verifying whether the network interface (e.g., the N3 interface) recovered from the fluctuation condition, or a combination thereof may be utilized by the learning engine 525 as training data. In some instances, the information or data related to validating the fluctuation condition, verifying whether the network interface recovered from the fluctuation condition, or a combination thereof may be utilized (e.g., by the learning engine 525) as feedback data to re-train or update the fluctuation prediction model such that fluctuation predications of the fluctuation prediction model may be improved based on feedback data. In some instances, the fluctuation prediction model may be implemented such that the detection or prediction of fluctuation may be automated. For example, fluctuation prediction or detection may be automated utilizing the technology disclosed herein. Alternatively, or in addition, in some instances, the technology disclosed herein may utilize the fluctuation predictions to proactively (or preemptively) management network maintenance, such as, e.g., generating (or otherwise providing) maintenance alerts or notifications, such that network maintenance may be automated.

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A system to mitigate fluctuation at network interfaces within telecommunications networks, the system comprising:
a processing system including one or more electronic processors configured to:
determine whether transmission of a ping included in a series of pings failed, wherein the series of pings are transmitted between a first network element of a telecommunications network and a second network element of the telecommunications network connected via a network interface of the telecommunications network, wherein transmission of the series of pings are associated with performance of a first connectivity test for the network interface;
determine whether an attempt to exchange a plurality of echo messages between the first network element and the second network element via the network interface generated an error indication message, wherein the attempt to exchange the plurality of echo messages are associated with performance of a second connectivity test for the network interface;
responsive to a determination that the ping failed and that the error indication message was generated, detect a fluctuation condition for the network interface; and
execute a recovery action responsive to the fluctuation condition for the network interface.

2. The system of claim 1, wherein the first network element is a centralized unit - user plane (CU-UP) network function of the telecommunications network, the second network element is a user plane function (UPF) of the telecommunications network, and the network interface is a N3 interface of the telecommunications network.

3. The system of claim 1, wherein the processing system is configured to execute the recovery action by restarting a network function pod associated with the network interface.

4. The system of claim 1, wherein the processing system is configured to:
control performance of the first connectivity test and the second connectivity test.

5. The system of claim 1, wherein the series of pings are transmitted from the first network element to the second network element.

6. The system of claim 1, wherein the plurality of echo messages includes:
an echo request transmitted from the first network element to the second network element; and
an echo response transmitted from the second network element to the first network element responsive to receipt of the echo request at the second network element.

7. The system of claim 6, wherein the error indication message is generated responsive to at least one of: a failed transmission of the echo response from the second network element to the first network element; or a delayed transmission of the echo response from the second network element to the first network element.

8. The system of claim 1, wherein the first network element is included in an open radio access network (O-RAN) of the telecommunications network and the second network element is included in a 5G core network of the telecommunications network.

9. A method to mitigate fluctuation at network interfaces within telecommunication networks, the method comprising:
determining, with a processing system including one or more electronic processors, whether transmission of a ping included in a series of pings failed, wherein the series of pings are transmitted between a first network element of a telecommunications network and a second network element of the telecommunications network connected via a network interface of the telecommunications network, wherein transmission of the series of pings are associated with performance of a first connectivity test for the network interface;
determining, with the processing system, whether an attempt to exchange a plurality of echo messages between the first network element and the second network element via the network interface generated an error indication message, wherein the attempt to exchange the plurality of echo messages are associated with performance of a second connectivity test for the network interface;
detecting, with the processing system, a fluctuation condition for the network interface when the ping failed and the error indication message was generated; and
executing, with the processing system, a recovery action responsive to the fluctuation condition for the network interface.

10. The method of claim 9, wherein determining, with the processing system, whether the transmission of the ping included in the series of pings failed includes detecting, with the processing system, that an alarm of an element management system was triggered.

11. The method of claim 9, wherein executing, with the processing system, the recovery action includes restarting a network function pod associated with at least one of the first network element or the second network element.

12. The method of claim 10, further comprising:
subsequent to executing, with the processing system, the recovery action:
accessing, with the processing system, data related to performance of the network interface;
detecting, with the processing system, a decreased performance of the network interface based on the data; and
validating, with the processing system, the fluctuation condition for the network interface based on the decreased performance of the network interface.

13. The method of claim 12, further comprising:
detecting, with the processing system, an increased performance of the network interface based on the data, wherein the increased performance occurs subsequent to the decreased performance; and
verifying, with the processing system, that the network interface recovered from the fluctuation condition.

14. The method of claim 12, further comprising:
detecting, with the processing system, based on the data, an absence of an increased performance of the network interface subsequent to the decreased performance of the network interface;
determining, with the processing system, that the network interface failed to recover from the fluctuation condition; and
executing, with the processing system, an additional recovery action.

15. The method of claim 14, wherein executing, with the processing system, the additional recovery action includes re-routing, with the processing system, a communication link between the first network element and the second network element.

16. The method of claim 14, wherein executing, with the processing system, the additional recovery action includes re-assigning, with the processing system, an internet protocol (IP) address associated with at least one of the first network element or the second network element.

17. The method of claim 12, wherein accessing, with the processing system, the data includes accessing, with the processing system, key performance indicator (KPI) data for the network interface.

18. A non-transitory computer-readable medium storing instructions that, when executed by one or more electronic processors of a processing system in a telecommunications network, cause the processing system to perform operations comprising:
determining whether transmission of a ping included in a series of pings failed, wherein the series of pings are transmitted between a first network element of the telecommunications network and a second network element of the telecommunications network connected via a network interface of the telecommunications network, wherein transmission of the series of pings are associated with performance of a first connectivity test for the network interface;
determining whether an attempt to exchange a plurality of echo messages between the first network element and the second network element via the network interface generated an error indication message, wherein the attempt to exchange the plurality of echo messages are associated with performance of a second connectivity test for the network interface;
detecting a fluctuation condition for the network interface when transmission of the ping failed and the error indication message was generated; and
executing a recovery action responsive to the fluctuation condition for the network interface.

19. The non-transitory computer-readable medium of claim 18, wherein executing the recovery action includes restarting a network function pod associated with at least one of the first network element or the second network element.

20. The non-transitory computer-readable medium of claim 18, further comprising:
subsequent to executing the recovery action:
determining, based on key performance indicator data for the network interface, that the network interface failed to recover from the fluctuation condition; and
executing an additional recovery action, the additional recovery action including at least one of:
re-routing a communication link between the first network element and the second network element; or
re-assigning, with the processing system, an internet protocol (IP) address associated with at least one of the first network element or the second network element.
